(19) United States
(12) Patent Application Publication
(10) Pub. No.: US 2022/0290868 A1
(43) Pub. Date: Sep. 15, 2022

(54) APPARATUS FOR A COOKING DEVICE, COOKING DEVICE, AND METHOD OF CLEANING A COOKING DEVICE

(71) Applicant: VESTEL ELEKTRONIK SANAYI VE TICARET A.S., Manisa (TR)

(72) Inventor: Erkan TÜNAY, Manisa (TR)

(73) Assignee: VESTEL ELEKTRONIK SANAYI VE TICARET A.S., Manisa (TR)

(21) Appl. No.: 17/624,802

(22) PCT Filed: Jul. 5, 2019
(86) PCT No.: PCT/EP2019/000200

§ 371 Date: Jan. 4, 2022

(51) Int. Cl. F24C 14/00; B08B 7/02; B08B 3/02; B08B 7/04; H05B 6/12

(52) U.S. Cl. CPC F24C 14/005; B08B 7/02; B08B 3/02; B08B 7/04; H05B 6/1209

(57) ABSTRACT

The present disclosure relates to an apparatus (100) for a cooking device. The apparatus (100) includes a flexible unit (110) having a surface (112) configured to support cooking ware, wherein the flexible unit (110) includes one or more fluid outlets (114) at the surface (112); at least one excitation device (120) configured to mechanically deform the flexible unit (110); a cleaning unit (130) configured to force a cleaning fluid through the one or more fluid outlets (114) and onto the surface (112) of the flexible unit (110); and a fluid collection structure (140) configured to collect the fluid on the surface (112).

### FIELD

Embodiments of the present disclosure relate to an apparatus for a cooking device, a cooking device having the apparatus, and a method of cleaning the cooking device. The embodiments of the present disclosure particularly relate to a removal of dirt from a cooking surface of a cooker, such as an induction cooker.

### BACKGROUND

Induction cookers have become increasingly popular because they do not require gas and are safe to use. Induction cookers generally include a smooth glass surface or glass ceramic surface, on which a pot or vessel can be placed for cooking. No metal pot holder or another equipment is required on the surface of the cooking device to hold the pot or vessel in place. Further, there is no pot balance problem because of the smooth glass surface.

During use of such induction cookers, a content of the pot or vessel may spill over and adhere to the hot glass surface. Such solidified dirt is difficult to remove from the glass surface. Blades can be used to scratch off the solidified dirt from the glass surface. However, this may be cumbersome and may damage the glass surface. Another method for cleaning glass surfaces uses a magnetic field. Yet another method uses chemical materials to remove the dirt. These methods are expensive and dangerous for home appliances.

In view of the above, new (cleaning) apparatuses for cooking devices and methods of cleaning a cooking device, that overcome at least some of the problems in the art are beneficial.

### SUMMARY

In light of the above, an apparatus for a cooking device, a cooking device having the apparatus, and a method of cleaning the cooking device are provided.

It is an object of the present invention to provide an apparatus for a cooking device, a cooking device having the apparatus, and a method of cleaning the cooking device, which can facilitate the removal of solidified dirt from a cooking surface of the cooking device, such as an induction cooker.

Further aspects, benefits, and features of the present disclosure are apparent from the claims, the description, and the accompanying drawings.

According to an independent aspect of the present disclosure, an apparatus for a cooking device is provided. The apparatus includes a flexible unit having a surface configured to support cooking ware, wherein the flexible unit includes one or more fluid outlets at the surface; at least one excitation device configured to mechanically deform the flexible unit; a cleaning unit configured to force a cleaning fluid through the one or more fluid outlets and onto the surface of the flexible unit; and a fluid collection structure configured to collect the fluid on the surface.

According to another independent aspect of the present disclosure, a cooking device is provided. The cooking device includes an apparatus which includes a flexible unit having a surface configured to support cooking ware, wherein the flexible unit includes one or more fluid outlets at the surface; at least one excitation device configured to mechanically deform the flexible unit; a cleaning unit configured to force a cleaning fluid through the one or more fluid outlets and onto the surface of the flexible unit; and a fluid collection structure configured to collect the fluid on the surface.

According to yet another independent aspect of the present disclosure, a method of cleaning a cooking device is provided. The method includes mechanically deforming a flexible unit by means of at least one excitation device such that dirt on a surface of the flexible unit is mechanically detached from the surface of the flexible unit, wherein the surface is configured to support cooking ware; and forcing a cleaning fluid through one or more fluid outlets at the surface of the flexible unit by means of a cleaning unit for a transport of the detached dirt to a fluid collection structure.

Embodiments are also directed at apparatuses for carrying out the disclosed methods and include apparatus parts for performing each described method aspect. These method aspects may be performed by way of hardware components, a computer programmed by appropriate software, by any combination of the two or in any other manner. Furthermore, embodiments according to the disclosure are also directed at methods for operating the described apparatus. The methods include method aspects for carrying out every function of the apparatus.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a schematic perspective view of an apparatus for a cooking device according to embodiments described herein;

FIG. 2 shows a flowchart of a method of cleaning a cooking device according to embodiments described herein; and

FIGS. 3A and B illustrate a cleaning of a cooking device according to embodiments described herein.

### DETAILED DESCRIPTION OF EMBODIMENTS

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

During use of a cooking device, a content of the pot or vessel may spill over and adhere to the hot glass surface. Such solidified dirt is difficult to remove from the glass surface. Blades can be used to scratch off the solidified dirt from the glass surface. However, this may be cumbersome and may damage the glass surface.

The present invention uses the flexible unit and the excitation device to change the shape of the cooking surface, whereby the solidified dirt is mechanically broken up or cracked and thus detached from the cooking surface. The dirt is then removed from the cooking surface by a fluid flow and collected in a fluid collection structure. Thus, an automatic and efficient cleaning of a cooking surface can be provided and a user convenience can be improved.

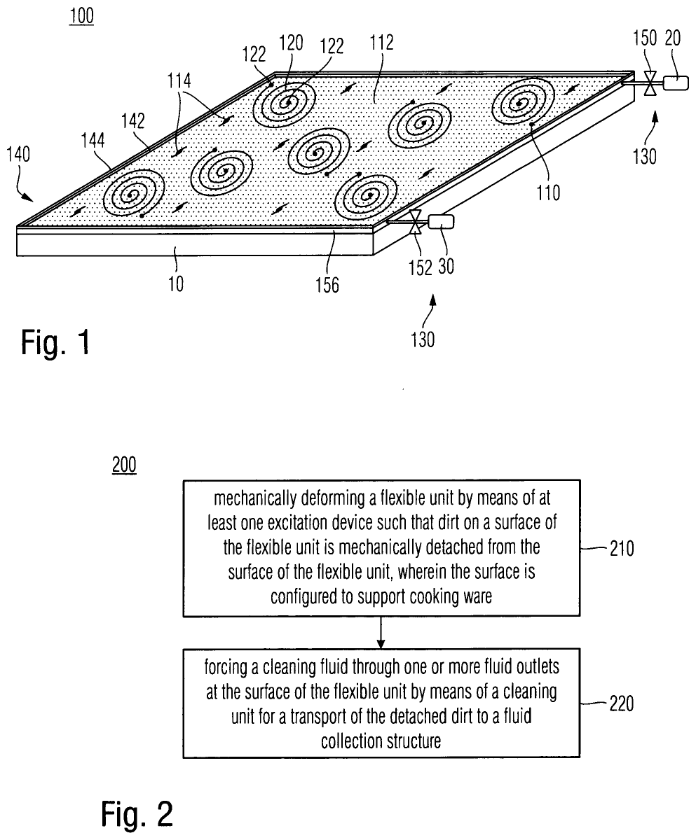

FIG. 1 shows a schematic perspective view of an apparatus 100 for a cooking device according to embodiments described herein.

The apparatus 100 includes a flexible unit 110 having a surface 112 configured to support cooking ware (not shown), wherein the flexible unit 110 includes one or more fluid outlets 114 at the surface 112; at least one excitation device 120 configured to mechanically deform the flexible unit 110; a cleaning unit 130 configured to force a cleaning fluid through the one or more fluid outlets 114 and onto the surface 112 of the flexible unit 110; and a fluid collection structure 140 configured to collect the fluid on the surface 112.

The apparatus 100 is comprised in the cooking device, such as an induction cooking device. The cooking device may include one or more heating elements, such as an induction heating element. The induction heating element utilizes an electrical current to create an electromagnetic field within a portion of the pot or vessel. As a result, an induced electrical current is created which in turn generates heat that can be transferred into an interior volume of the pot or vessel for heating food items placed therein.

The present disclosure, however, is not limited to induction cooking devices and the cleaning apparatus of the present disclosure can be used in combination with other cooking devices, and in particular cooking devices having a flat cooking surface. These may include cooking devices which use conduction heating and/or gas.

The surface 112 of the apparatus 100 is configured to support cooking ware, such as a pot or vessel, and can also be referred to as a “cooking surface”. The surface 112 may be a smooth flat surface during use (i.e., cooking), and may be deformable during cleaning to remove solidified dirt.

According so some embodiments, the cooking device includes a hot plate 10. The hot plate 10 may be made of glass or glass ceramic. The hot plate 10 may include at least one hob configured such that the pot or vessel can be placed thereon for cooking. For example, the at least one of hob can be one, two, three, four, five, or even more hob(s). Each hob can correspond to a defined area of the cooking surface 112.

In some implementations, the apparatus 100 covers at least a part of the hot plate 10, and in particular covers an area of the hot plate 10 which includes the at least one hob. Preferably, the apparatus 100 covers the hot plate 10 entirely. In further implementations, the apparatus 100 is comprised in the hot plate 10. In other words, the apparatus 100 and the hot plate 10 may form one entity.

According to some embodiments, the flexible unit 110 includes, or is made of, an elastic material, in particular an elastic polymer. The material of the flexible unit 110 is selected such that the flexible unit 110 is deformable by the at least one excitation device 120 to detach solidified dirt from the surface 112 thereof. In some embodiments, the flexible unit 110 is a flexible polymer cover, and in particular a transparent flexible polymer cover. The flexible unit 110 may be configured to withstand heat generated during cooking.

The flexible unit 110 may be connected to the apparatus 110 or the hot plate 10 at a periphery thereof, and may not be connected to the apparatus 110 or the hot plate 10 at a center portion thereof. When the cleaning fluid is introduced below the flexible unit 110, e.g. between the flexible unit 110 and the hot plate 10, the flexible unit 110 bulges at the center portion.

The bulge may have at least two beneficial effects. First, the one or more fluid outlets 114, which may extend through the flexible unit 110, are widened such that a fluid can flow therethrough. Second, the cleaning fluid may flow down the bulge to the fluid collection structure 140 at a periphery of the flexible unit 110.

In some implementations, the one or more outlets 114 may extend through, or penetrate, the flexible unit 110. For example, the flexible unit 110 may be a sheet and the one or more outlets 114 may extend through the flexible unit 110 in a thickness direction thereof. The one or more outlets 114 may be slits or pores in the flexible unit 110.

The one or more outlets 114 can be a plurality of outlets 114 arranged along virtual parallel lines on the surface 112, as it is shown in the example of FIG. 1. The plurality of outlets 114 can be arranged such that a sufficient amount of cleaning fluid is provided to the surface 112 to remove the detached dirt.

According to some embodiments, the at least one excitation device 120 is embedded in the flexible unit 110. For example, the at least one excitation device 120 can be embedded in the elastic material, such as the elastic polymer. In other embodiments, the at least one excitation device 120 can be provided at a surface of the flexible unit 110 opposite to the cooking surface 112.

The at least one excitation device 120 can be located such that the one or more outlets 114 are enlarged or widened when the at least one excitation device 120 is driven. Thereby, a flow of the cleaning fluid through the one or more outlets 114 and onto the surface 112 can be improved. For example, the at least one excitation device 120 can be provided between at least two of the one or more outlets 114, as it is illustrated in the example of FIG. 1.

In some embodiments, the flexible unit 114 can be configured such that the one or more outlets 114 are essentially closed when the at least one excitation device 120 is not operated or driven. When the at least one excitation device 120 is operated or driven, the one or more outlets 114 can be enlarged or widened to open up. Thereby, it can be prevented that dirt flows into the one or more outlets 114 during cooking.

In some implementations, the at least one excitation device 120 includes, or is, made of metal configured to expand when current is applied thereto. The at least one excitation device 120 may be made of a metal having a high expansion coefficient. When current is applied to the at least one excitation device 120, the at least one excitation device 120 expands and the flexible unit 110 is deformed or wrinkled such that solidified dirt is detached from the surface 112 and can be transported away by the cleaning fluid.

According to some embodiments, the at least one excitation device 120 has a spiral shape. The spiral may have two pins 122 for electrical connection to a power source and/or a controller unit configured to operate or drive the at least one excitation device 120.

In some implementations, the cleaning unit 130 includes an inlet valve 150 and an outlet valve 152. The inlet valve 150 is configured to control a cleaning fluid supply (e.g., clean water supply) to the cleaning unit 140. The outlet valve 152 is configured to control a cleaning fluid discharge (e.g., dirt water discharge) from the cleaning unit 130. The cleaning fluid may be water, and in particular tap water. For example, the inlet valve 150 may be connected to a tap water supply 20. In addition, or alternatively, the outlet valve 152 may be connected to a discharge pump 30. The discharge pump 30 may be included in the apparatus 100 or may be provided separately.

In some implementations, the cleaning unit 130 is configured to force the cleaning fluid through the one or more fluid outlets 114 with a pressure such that the flexible unit 110 bulges in a center portion thereof. The pressure can be provided by the tap water supply 20 and/or may be controlled by means of the inlet valve 150. The inlet valve 150 can be controlled by a controller unit to supply the cleaning fluid to the cleaning unit 130 and perform the cleaning operation.

According to some embodiments, the fluid collection structure 140 is provided at an edge portion or a circumference of the flexible unit 110.

In some implementations, the fluid collection structure 140 includes a fluid collection channel 142. For example, the fluid collection channel 142 may at least partially surround the flexible unit 110. Preferably, the fluid collection channel 142 surrounds the flexible unit 110 entirely. The fluid collection channel 142 receives cleaning fluid which has passed through the one or more outlets 114 and has flown along the surface 112 to remove the detached dirt therefrom. The fluid collection channel 142 may be in fluid communication with the outlet valve 152 via a fluid hole 156.

In some embodiments, the fluid collection structure 140 includes a fluid barrier 144 provided at an edge portion or circumference of the flexible unit 110. The fluid barrier 144 may prevent cleaning fluid from falling off the surface 112 and/or may guide the cleaning fluid to the fluid collection channel 142. For example, the fluid barrier 144 may be provided at an outer circumference of the fluid collection channel 142. In some embodiments, the fluid barrier 144 at least partially, or even entirely, surrounds the fluid collection channel 142.

The fluid barrier 144 may be a protrusion or rib which protrudes from the cooking surface 112 and/or higher than the cooking surface 112. The fluid barrier 144 may protrude sufficiently high to prevent cleaning fluid from overflowing the fluid barrier 144.

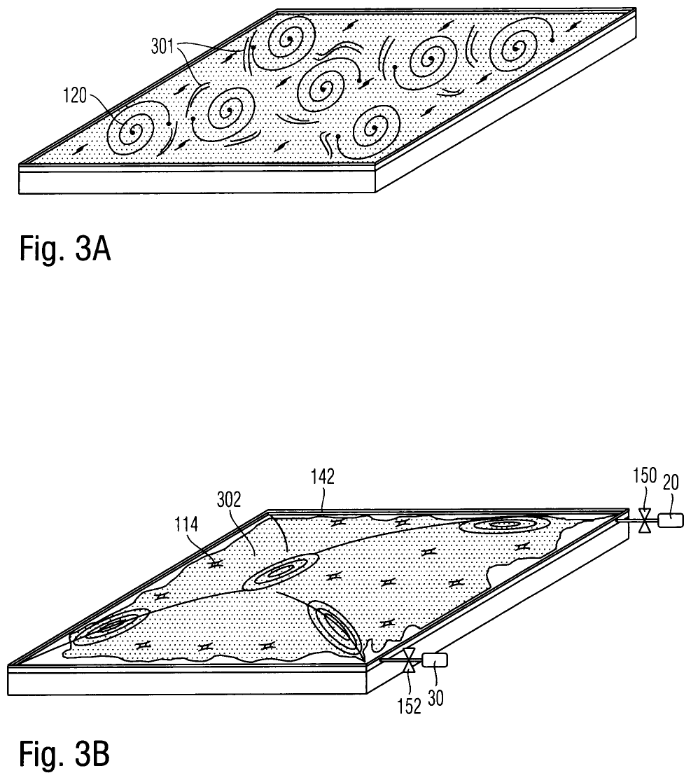

A detailed operation of the apparatus 100 is explained in the following with reference to FIGS. 2, 3A and 3B.

FIG. 2 shows a flowchart of a method 200 for cleaning a cooking device according to embodiments described herein. FIGS. 3A and B illustrate a cleaning of a cooking device according to embodiments described herein.

The method 200 includes in block 210 mechanically deforming a flexible unit by means of at least one excitation device such that dirt on a surface of the flexible unit is mechanically detached from the surface of the flexible unit, wherein the surface is configured to support cooking ware; and in block 220 forcing a cleaning fluid through one or more fluid outlets at the surface of the flexible unit by means of a cleaning unit for a transport of the detached dirt to a fluid collection structure.

In some embodiments, the at least one excitation device is periodically driven such that the flexible unit expands and contracts a predetermined number of times. Thereby, it can be ensured that the dirt is detached from the surface of the flexible unit 110.

According to embodiments described herein, the method 200 of for cleaning a cooking device can be conducted by means of computer programs, software, computer software products and the interrelated controllers, which can have a CPU, a memory, a user interface, and input and output means being in communication with the corresponding components of the apparatus.

FIGS. 3A and 3b show the two main parts of the working principle of the present disclosure. The first part is an excitation of the at least one excitation device to create wrinkles 301 on the flexible unit to mechanically detach dirt from the surface thereof. The second part is to force the cleaning fluid 302 through the one or more outlets onto the surface to be cleaned, wherein the cleaning fluid 302 removes the detached dirt and transports the detached dirt to the fluid collection structure 140. The dirt water collected in the fluid collection structure 140 can be discharged using the discharge pump connected to the outlet valve.

The method or working principle of the present invention can be implemented using a controller unit of the apparatus. The controller unit is configured to operate the at least one excitation device configured to mechanically deform the flexible unit such that dirt on the surface of the flexible unit is mechanically detached from the surface of the flexible unit. The controller unit is further configured to operate the cleaning unit (e.g. the inlet valve and/or the outlet valve and/or the discharge pump) to force the cleaning fluid through the one or more fluid outlets for a transport of the detached dirt to the fluid collection structure.

In some embodiments, the controller unit is configured to control or drive the at least one excitation device periodically such that the flexible unit expands and contracts a predetermined number of times. Thereby, it can be ensured that the dirt is detached from the surface of the flexible unit.

The controller unit, which can be a microcontroller, can implement the following working algorithm.

First, a cleaning operation is started. For example, a cleaning button can be used for a manually controlled cleaning operation, or the controller unit can be used for an automatic control of the cleaning operation.

Second, as it is illustrated in FIG. 3A, the at least one excitation device is driven. For example, metal spirals having a high thermal expansion coefficient are excited by an electric current in a random order or one by one, and the elastic cover is stretched and shrunk. In this way, dirt is mechanically detached from the cooking surface.

Third, the driving of the at least one excitation device is stopped.

Fourth, the inlet valve, which may be a tap water network water valve, is opened. Cold network water is filled under the flexible cover and a camber occurs in the middle of the flexible cover as it is illustrated in FIG. 3B. The pores in the cover surface are opened because of the stretching of the flexible cover. Water leaks to the surface and, because of the bulge, flows to the edges of the flexible cover together with the dirt.

Fifth, the discharge pump and outlet valve are activated for a waste water discharging operation.

The present invention uses the flexible unit and the excitation device to change the shape of the cooking surface, whereby the solidified dirt is mechanically broken up or cracked and thus detached from the cooking surface. The dirt is then removed from the cooking surface by a fluid flow and collected in a fluid collection structure. Thus, an automatic and efficient cleaning of a cooking surface can be provided and a user convenience can be improved. This system can be operated by a microcontroller or a simple sensor-actuator mechanism.

While the foregoing is directed to embodiments of the disclosure, other and further embodiments of the disclosure may be devised without departing from the basic scope thereof, and the scope thereof is determined by the claims that follow.

1. An apparatus (100) for a cooking device, comprising:
a flexible unit (110) having a surface (112) configured to support cooking ware, wherein the flexible unit (110) includes one or more fluid outlets (114) at the surface (112);
at least one excitation device (120) configured to mechanically deform the flexible unit (110);
a cleaning unit (130) configured to force a cleaning fluid through the one or more fluid outlets (114) and onto the surface (112) of the flexible unit (110); and
a fluid collection structure (140) configured to collect the fluid on the surface (112).

2. The apparatus (100) of claim 1, wherein the flexible unit (110) includes, or is made of, an elastic material, in particular an elastic polymer.

3. The apparatus (100) of claim 1 or 2, wherein the one or more outlets (114) are slits in the flexible unit (110).

4. The apparatus (100) of any one of claims 1 to 3, wherein the at least one excitation device (120) is embedded in the flexible unit (110).

5. The apparatus (100) of any one of claims 1 to 4, wherein the at least one excitation device (120) includes, or is made of, a metal configured to expand when current is applied thereto.

6. The apparatus (100) of any one of claims 1 to 5, wherein the at least one excitation device (120) has a spiral shape.

7. The apparatus (100) of any one of claims 1 to 6, wherein the cleaning unit (130) is configured to force the cleaning fluid through the one or more fluid outlets (114) with a pressure such that the flexible unit (110) bulges at a center portion thereof.

8. The apparatus (100) of any one of claims 1 to 7, wherein the fluid collection structure (140) is provided at an edge portion of the flexible unit (110).

9. The apparatus (100) of any one of claims 1 to 8, wherein the fluid collection structure (140) includes a fluid collection channel (142).

10. The apparatus (100) of claim 9, wherein the fluid collection channel (142) at least partially surrounds the flexible unit (110).

11. The apparatus (100) of any one of claims 1 to 10, further including a controller unit configured to:
operate the at least one excitation device (120) configured to mechanically deform the flexible unit (110) such that dirt on the surface (112) of the flexible unit (110) is mechanically detached from the surface (112) of the flexible unit (110); and
operate the cleaning unit (130) to force the cleaning fluid through the one or more fluid outlets (114) for a transport of the detached dirt to the fluid collection structure (140).

12. A cooking device, including the apparatus (100) of any one of claims 1 to 11.

13. The cooking device of claim 12, wherein the apparatus (100) covers a hot plate (10) of the cooking device.

14. The cooking device of claim 12 or 13, wherein the cooking device is an induction cooker.

15. Method (200) of cleaning a cooking device, comprising:
mechanically deforming (210) a flexible unit (110) by means of at least one excitation device (120) such that dirt on a surface of the flexible unit (110) is mechanically detached from the surface (112) of the flexible unit (110), wherein the surface (112) is configured to support cooking ware; and
forcing a cleaning fluid through one or more fluid outlets (114) at the surface (112) of the flexible unit (110) by means of a cleaning unit (130) for a transport of the detached dirt to a fluid collection structure (140).
